(19) United States
(12) Patent Application Publication
(10) Pub. No.: US 2025/0242962 A1
(43) Pub. Date: Jul. 31, 2025

(54) CONTAINER LABELING SYSTEM

(71) Applicant: P.E. LABELLERS S.P.A., Porto Mantovano (IT)

(72) Inventor: Luca BONARDI, San Giorgio Bigarello (IT)

(21) Appl. No.: 18/855,832

(22) PCT Filed: Mar. 30, 2023
(86) PCT No.: PCT/EP2023/058371

§ 371 Date: Oct. 10, 2024

(30) Foreign Application Priority Data
Apr. 14, 2022 (IT) 102022000007439

(51) Int. Cl. B65C 9/40; B65C 9/02

(52) U.S. Cl. CPC B65C 9/40; B65C 9/02; B65C 2009/407

(57) ABSTRACT

A container labeling system includes a labeling machine, provided with at least one conveyor for containers to be labeled and at least one labeling assembly, and at least one optical sensor which is configured to detect the presence of the respective label on each one of the containers. A configuration device is functionally connected to the optical sensor and provided with at least one memory, in which multiple operating configurations of the optical sensor are stored, with selection elements for the choice by an operator of one of the operating configurations, and with a transceiver for sending the chosen operating configuration to the optical sensor.

The present invention relates to a container labeling system.

As is known, labeling machines are currently used for labeling objects such as, for example, containers, which make it possible to automatically apply labels on containers to be labeled.

These machines generally have conveyance means which make it possible to move the containers to be labeled along an advancement path.

Laterally to the conveyance means, the labeling machines furthermore have at least one labeling assembly, which transfers a respective label onto the individual containers in transit on the conveyance means.

Downstream of the labeling assembly, along the direction of advancement of the containers on the conveyance means, there is usually an optical sensor of presence, commonly constituted by a photocell, the function of which is to detect the presence, if any, of the labels on each container originating from the labeling assembly.

In particular, if the optical sensor detects that labels on the containers are missing, means are activated on the labeling machine that make it possible to discard the containers that do not bear labels.

The labels that the labeling assembly is called on to apply can be of various formats, and can have dimensions, colors or other characteristics that differ between formats.

Currently, with each new fitting-out of the labeling assembly with labels of a determined format, it is necessary, before starting up the machine, to set the optical sensor to recognize the new format of the labels that will be applied on the containers by the labeling assembly.

In order to set the optical sensor to recognize a new label format, it is necessary for an operator to make the optical sensor acquire data for recognizing the labels affixed to the containers, in order to render it capable of distinguishing containers with the label in the new format affixed to them from containers without a label. In the jargon, the set of this data is called a “recipe”.

To set a new recipe on the optical sensor, the operator, at each change of format of the labels, must manually position, before the optical sensor, a series of sample examples of containers with and without labels, which in practice are constituted by a series of containers with a respective label in the new format applied to them which the optical sensor will be called on to detect during the subsequent operation, and by a series of containers without labels, so that the optical sensor can acquire and store the recognition data necessary to enable the optical sensor in a small local memory, located onboard the optical sensor, to positively distinguish, during the operation of the machine, containers with the label in the new format applied to them from containers without a label. The small size of the local memory onboard the optical sensor forces the operator to repeat the operations to load the recipe into the memory of the sensor every time a change of format of the labels is made on the labeling machine.

It is clear that the execution of these operations to load a new recipe for every change of format of the labels translates to long machine shutdown times between one job with one label format and another with a different label format, as well as being quite inconvenient for the operators, considering that there may be many changes of format of the labels over the course of a working day.

The aim of the present invention is to provide a container labeling system which is capable of improving the known art in one or more of the above-mentioned aspects.

Within this aim, an object of the invention is to provide a container labeling system that makes it possible to considerably speed up and simplify the operations to set the optical sensor at each change of format of the labels.

Another object of the invention is to provide a labeling system that makes it possible to avoid or, at least, to considerably limit the need for a manual intervention of operators to set the optical sensor at each change of format of the labels.

Another object of the invention is to provide a labeling system that avails of relatively simple and economic optical sensors for the detection of the presence of labels on the containers.

A further object of the present invention is to overcome the drawbacks of the background art in a manner that is alternative to any existing solutions.

Another object of the invention is to provide a container labeling system that is highly reliable and relatively easy to provide and which can be competitive from a purely economic viewpoint as well.

This aim and these and other objects which will become better apparent hereinafter are achieved by a labeling machine according to claim 1, optionally provided with one or more of the characteristics of the dependent claims.

Further characteristics and advantages of the invention will become better apparent from the description of preferred, but not exclusive, embodiments of the labeling machine according to the invention, which are illustrated for the purposes of non-limiting example in the accompanying drawings wherein:

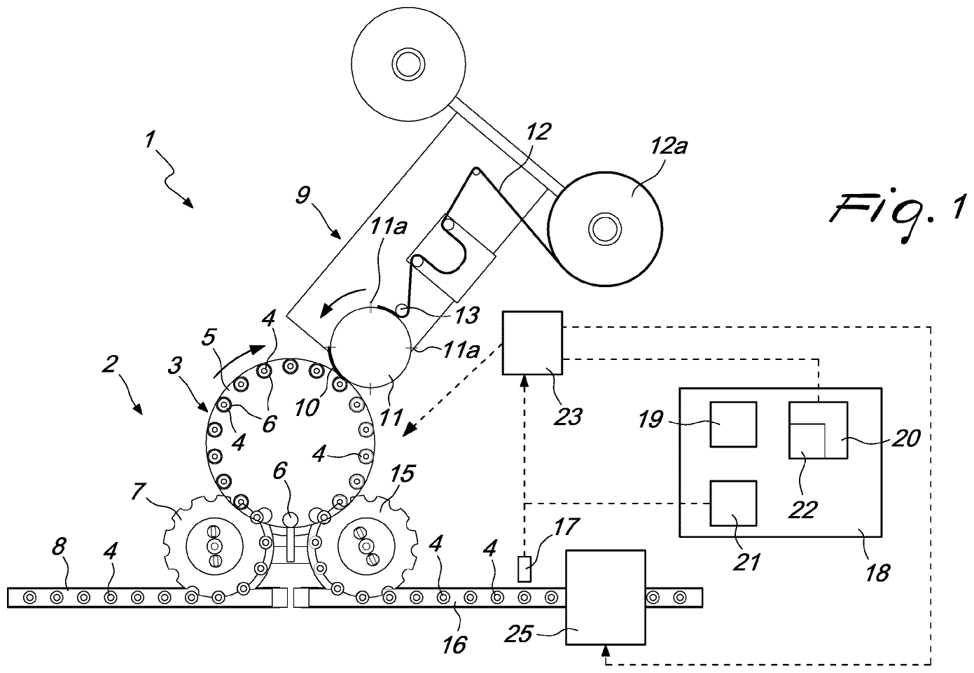

FIG. 1 is a schematic plan view from above of the system according to the invention.

With reference to the FIGURE, the labeling system according to the invention, generally designated by the reference numeral 1, comprises a labeling machine 2, which is provided with at least one conveyor 3 for conveying containers 4 to be labeled along an advancement path.

Conveniently, the conveyor 3 comprises at least one carousel 5, which rotates about its own axis and which has at its peripheral region a plurality of pans 6, which are, in turn, designed to receive a respective container 4, in resting contact thereon, from an input star conveyor 7, which is fed, for example, by a first linear conveyor 8, and which can be moved in rotation in order to make the corresponding containers 4 rotate about its axis.

The labeling machine 2 is further provided with at least one labeling assembly 9 the function of which is to apply a respective label 10 on each one of the containers 4 in transit on the conveyor 3.

In particular, each labeling assembly 9 is positioned along the perimeter of the carousel 5 and can be, for example, provided with a transfer drum 11, which makes it possible to affix, on the containers 4 arriving from the carousel 5, the provided labels 10, in a manner per se known, by cutting a label ribbon 12 taken, by way of an unwinder 13, from a respective spool 12a, supported by the labeling assembly 9, with the optional interposition of a tensioning device 14, which is per se known.

For example, the cutting of the labels 10 from the label ribbon 12 can be performed by blades 11a mounted on the transfer drum or by a cutting roller, not shown, located upstream of the transfer drum 11, with respect to the direction of advancement of the label ribbon 12.

Advantageously, the conveyor 3 further comprises an output star conveyor 15, which unloads the containers 4 labeled at the labeling assembly 9 from the carousel 5 and conveys them to a second linear conveyor 16, which is used to send the labeled containers 4 for further processing.

The system according to the invention comprises at least one optical sensor 17 which is configured to detect the presence of the respective label 10 on each one of the containers 4, and therefore to recognize the containers 4 on which the labels 10 have actually been applied.

In particular, the optical sensor 17 is arranged downstream of the labeling assembly 9 along the direction of advancement of the containers 4 on the conveyor 3.

For example, the optical sensor 17 can be positioned along the second linear conveyor 16 or, alternatively, it can be positioned at the carousel 5.

In particular, the optical sensor 17 is constituted by a photocell.

For example, the optical sensor 17 can also be constituted by a vision sensor, like the one commercially known as “Smart-VS” made by the Datasensing company.

The peculiarity of the system according to the invention consists in that it further comprises a configuration device 18, which is functionally connected to the optical sensor 17.

Such configuration device 18 comprises at least one memory 19, which is capable of storing multiple operating configurations of the optical sensor 17.

Each one of the operating configurations stored in the memory 19 constitutes, in practice, a “recipe” and makes it possible to configure the optical sensor 17, so as to enable the optical sensor 17 to detect the presence of a respective format of the labels 10 on the containers 4.

In the memory 19, each one of the operating configurations is, conveniently, associated with a respective name or other sign or identification data, so as to enable its easy selection by the operator. Such name can be set by the operator, as will be explained below.

In particular, the optical sensor 17 is configurable according to one of the operating configurations, so as to be capable, once configured, of recognizing the presence on the containers 4 of labels 10 in the format that corresponds to the operating configuration with which it has been configured.

The configuration device 18 is provided with selection means 20, which are configured to enable the operator to choose one of the operating configurations stored in the memory 20.

The configuration device 18 is also provided with transceiver means 21, which are configured to send the operating configuration chosen by the operator, by way of the selection means 20, to the optical sensor 17.

In turn, the optical sensor 17 can be configured according to the operating configuration chosen by the operator, so that, once the operating configuration chosen by the operator is received via the transceiver means 21, the optical sensor 17 is capable of detecting on the containers 4 the presence of the format of the labels 10 that corresponds to the operating configuration chosen by the operator.

In particular, each one of the operating configurations stored in the memory 19 comprises at least one respective parameter for the detection of the presence of the label 10 in the respective format on each one of the containers 4 by the optical sensor 17.

For example, such respective parameter of each operating configuration can be constituted by at least one data item relating to the contrast or the brightness of a container 4 with a label of the relevant format applied on it and/or of a container 4 without a label 10 of the relevant format.

In this case, based on the comparison of such data item with the data item of the same parameter detected for each container 4 that passes in front of it, the optical sensor 17 performs the recognition of containers 4 with the label 10 applied thereto in the format that corresponds to the operating configuration with which it is configured.

According to a possible embodiment, each one of the operating configurations is constituted by at least one respective image, or at least a part of an image, of a container 4 on which a label in the respective format is applied.

Conveniently, again according to such embodiment, each one of the operating configurations can comprise at least one respective image of a container without a label in the respective format.

More specifically, each one of the operating configurations can comprise a set of images, of which at least one is an image of a container 4 on which a label in the respective format is applied and at least another is an image of a container without a label in the respective format.

In this case, the optical sensor 17, once configured with one of the operating configurations, is capable of comparing the image acquired of each container 4 which in each instance has passed in front of the optical sensor 17, with the images of the operating configuration with which it is configured and, on the basis of such comparison, is capable of detecting the presence, if any, on the containers 4 of the format of the labels 10 that corresponds to the operating configuration with which it has been configured.

In a preferred embodiment, the configuration device 18 comprises a computer.

The configuration device 18 can be installed directly on the labeling machine 2. Alternatively, the configuration device 18 can also be installed outside of the labeling machine 2. For example, it can be installed in a location spaced apart from the location where the labeling machine 2 is located, such as, for example, a different room from the room where the labeling machine 2 is located.

The operational connection between the configuration device 18 and the optical sensor 17 can be provided by cable or by a wireless connection.

In other possible embodiments it is possible for the operational connection between the configuration device 18 and the optical sensor 17 to be provided via the internet.

Conveniently, the transceiver means 21 comprise at least one first communication module installed at the optical sensor 17 for communicating data and information to and from the optical sensor 17.

Advantageously, the transceiver means 21 comprise at least one second communication module connected to the configuration device 18 and adapted to communicate with the first communication module, in order to allow the transmission of data and information and in particular of operating configurations between the configuration device 18 and the optical sensor 17.

Preferably, the data transmission between the configuration device 18 and the optical sensor 17 using the first and the second communication module is conducted using a TCP/IP protocol.

Advantageously, the selection means 20 of the configuration device 18 comprise at least one user interface device 22.

For example, the user interface device 22 can be constituted by a keypad and a mouse.

More preferably, the user interface device 22 comprises at least one touchscreen installed on the labeling machine 2. In particular, the touchscreen is positioned in a position accessible by the operator in order to allow the operator to easily interact with the graphical interface displayed on the touchscreen in order to execute the selection of the chosen operating configuration for the optical sensor 17.

Optionally, the user interface device 22 can also be functionally connected to control and command means 23 of the labeling machine 2 in order to allow the operator to command or set the operation of the labeling machine 2 by way of the user interface device 22.

It is also possible by way of the user interface device 22 for the operator to interact with the optical sensor 17 in order to set its operating modes.

The control and command means 23 are, advantageously, constituted by an electronic control unit that oversees the operation of the labeling machine 2.

Conveniently, the optical sensor 17 and the control and command means 23 can be functionally connected to each other, so that the optical sensor 17 can send signals to the control and command means 23 and the control and command means 23 can vary the operation of the labeling machine 2, based on the signals received from the optical sensor 17.

In particular, the labeling machine 2 can be provided, downstream of the optical sensor 17, along the direction of advancement of the containers 4 on the conveyor 3, with ejection means 25, per se known, which are adapted to eject unlabeled containers 4 from the conveyor 3.

Such ejection means 25 are, conveniently, activatable by the control and command means 23 upon receipt by the control and command means 23 of a signal that arrives from the optical sensor 17 indicating the absence of the label 10 in one of the containers 4 passing in front of the optical sensor 17, in order to allow the ejection of that container without a label 10 from the flow of containers 4 in transit on the conveyor 3.

The operation of the system, according to the invention, is the following.

The first time the labeling machine 2 is used, the operator installs a spool 12a of label ribbon 12 on the labeling assembly 9, bearing labels 10 of a first format.

At this point, the operator by way of the user interface device 22 sets the operation of the labeling machine 2 so that a group of containers 4 in transit on the conveyor 3 are labeled by the labeling assembly 9 and another group of containers 4 in transit on the conveyor 3 are not labeled by the labeling assembly 9.

The optical sensor 17 is also set by the operator, again using the user interface device 22, to a learning mode, in order to acquire the necessary parameters for recognizing the format of the labels applied on the containers 4.

The labeled and unlabeled containers 4 are then transported by the conveyor 3 in front of the optical sensor 17, which proceeds to acquire the parameters necessary for the recognition of the format of the labels applied to the containers 4.

For example, the optical sensor 17 acquires images of the labeled containers 4 and of the unlabeled containers 4 and sends these images to the configuration device 18 which creates in the memory 19 a first operating configuration relating to the first format of the labels 10, using the set of images thus acquired by the optical sensor 17.

Using the user interface device 22, the operator can associate a name with the operating configuration thus created, and this name will also be stored in the memory 19 and can refer to the format that corresponds to the operating configuration created, so as to facilitate its retrieval and consequent selection.

At this point, the operator can repeat these operations for all the other formats of labels 10 that will be used on the labeling machine 2, in so doing storing in the memory 19 multiple operating configurations of the optical sensor 17, each one conveniently given a different name.

In this manner, for each format of the labels 10 that will be used on the labeling machine, a corresponding operating configuration of the optical sensor 17 will be available in the memory 19 of the configuration device 18.

Once the system is thus prepared, then, during the normal operation of the labeling machine 2, the operator, when the format of the labels 10 on the labeling machine 2 is changed, will simply need to select, using the user interface device 22, the new format of labels 10 that will be applied to the containers 4, for example by indicating the name used for the corresponding operating configuration.

Once the operator has selected the new format of the labels 10, the configuration device 18 will send the operating configuration corresponding to the format of the labels 10 selected by the operator to the optical sensor 17, so that the optical sensor 17 will be configured to recognize the presence on the containers 4 of labels 10 of the selected format.

The operator can then command, using the user interface device 22, the start-up of the labeling machine 2 for the application of the labels 10 of the new format on the containers 4.

At this point, the optical sensor 17, when a container 4 with a label 10 of the new format applied on it passes in front of it, will recognize the presence of the label 10 and will send a corresponding signal to the control and command means 23.

If it should happen that one or more containers 4 are not labeled by the labeling unit 9, because, for example, of a malfunction or because the spool 12a runs out, the optical sensor 17 would detect the absence of a label from such containers 4 and would send a label absent signal to the control and command means 23, which as a consequence would activate the ejection means 25, in order to eject every container 4 without a label 10 from the conveyor 3.

In practice it has been found that the invention fully achieves the intended aim and objects by providing a labeling system that enables operators to easily configure the optical sensor to detect the presence of labels on containers at each change of format of the labels being processed.

The invention thus conceived is susceptible of numerous modifications and variations, all of which are within the scope of the appended claims. Moreover, all the details may be substituted by other, technically equivalent elements.

In practice, the materials used, as well as the contingent shapes and dimensions, may be any according to the requirements and to the state of the art.

The disclosures in Italian Patent Application No. 102022000007439 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-7. (canceled)

8. A container labeling system, comprising:
a labeling machine which comprises at least one conveyor for conveying containers to be labeled along an advancement path and at least one labeling assembly which is configured to apply a respective label to each one of said containers that transit on said conveyor, and
at least one optical sensor configured to detect the presence of said respective label on each one of said containers and therefore to recognize said containers on which said respective labels are actually applied, said optical sensor being arranged downstream of said labeling assembly along a direction of advancement of said containers on said conveyor,
wherein said system further comprises a configuration device which is functionally connected to said optical sensor, said configuration device comprising:
at least one memory, in which multiple operating configurations of said optical sensor are stored, each one of said multiple operating configurations being adapted to configure said optical sensor so as to detect the presence of a respective format of labels on said containers,
selection means configured for a selection of one of said operating configurations by an operator, and
transceiver means configured to send said one operating configuration, chosen by means of said selection means, to said optical sensor,
said optical sensor being configurable according to said one operating configuration.

9. The system according to claim 8, wherein each one of said multiple operating configurations comprises at least one respective parameter for detection of the presence of said label of said respective format on each one of said containers by said optical sensor.

10. The system according to claim 8, wherein each one of said multiple operating configurations comprises at least one respective image of a container on which a label of said respective format is applied.

11. The system according to claim 8, wherein each one of said multiple operating configurations comprises at least one respective image of a container without a label of said respective format.

12. The system according to claim 8, wherein said configuration device comprises a computer.

13. The system according to claim 8, wherein said selection means of said configuration device comprise at least one user interface device.

14. The system according to claim 13, wherein said user interface device comprises at least one touchscreen installed on said labeling machine.
